(19) United States
(12) Patent Application Publication
(10) Pub. No.: US 2005/0247571 A1
(43) Pub. Date: Nov. 10, 2005

(54) Contaminant removal apparatus and installation method

(75) Inventor: Brian Grigg, Graceville (AU)

Correspondence Address: HUSCH & EPPENBERGER, LLC, 190 CARONDELET PLAZA, SUITE 600, ST. LOUIS, MO, 63105-3441, US

(73) Assignee: Aquenox Pty Ltd, Victoria (AU)

(21) Appl. No.: 10/510,797

(22) PCT Filed: Apr. 8, 2003
(86) PCT No.: PCT/AU03/00423

§ 371 Date: Jun. 9, 2005

(30) Foreign Application Priority Data
Apr. 8, 2002 (AU) PS 1609
Nov. 15, 2002 (AU) 2002952678
Nov. 19, 2002 (AU) 2002952743

(51) Int. Cl. C02F 1/461

(52) U.S. Cl. 205/743

(57) ABSTRACT

This invention relates to a method of installation of an electrocoagulation (EC) system to remove contaminants from wastewater which includes the steps of: (i) measuring conductivity of the wastewater; (ii) from the result obtained in step (i) determining the number of electrically connected electrodes or unipolar electrodes required in the EC system for efficient removal of the contaminants, and (iii) from step (ii) assessing a range of current and/or voltage to be applied to an EC cell included in the EC system.

### FIELD OF INVENTION

This invention is concerned with methods of removing contaminants, impurities, additives and/or hazardous materials from aqueous waste streams from industrial, mining or nuclear processes, contaminated bodies of water, sewage, abattoirs, laundrettes, hotels and car washes. In particular, the invention relates to a method of installation of an electrocoagulation apparatus that can remove metal species, oils, greases, detergents, suspended matter, petrochemicals, biological and non-biological organic compounds and the like from wastewater.

### BACKGROUND OF THE INVENTION

Treatment and recycling of wastewater is an increasingly essential utility worldwide as waterways and ground water become increasingly is polluted by industrial and human waste. In conditions where water is at a premium, such as geographical areas that have very little rainfall, ships and aeroplanes, water recycling is essential.

Water purity regulations, which specify acceptable levels for a wide range of contaminants in water discharged into waterways, sewer systems or discharged in other manners, are becoming more restrictive and stringent. Older methods of contamination removal or water purification are not suitably efficient for meeting the stricter water purity standards that are now demanded. Other methods of wastewater treatment are expensive and require the addition of chemicals to the wastewater. High volumes of sludge are also produced as by-products which have to be disposed of.

Industrial processes are heavy users of municipal water and produce water contaminated with heavy metals, such as uranium, cyanide, lead, mercury and arsenic, hydrocarbons, such as oils and greases, and suspended solids of a wide variety of components. Industrial processes that create contaminated water include power stations, mining processes, chemical factories, the textile industry, manufacturing industry and metal processing operations.

There are many industries that produce large amounts of wastewater, such as industrial laundries, hotels, cruise ships, aeroplanes, abattoirs, petrochemical industry and hospitals. Such wastewater would contain contaminants such as detergents, oils, greases, metal species, radioactive metal species, suspended matter, petrochemicals, biological and non-biological organic compounds and food and beverage waste.

Electrocoagulation technology or use of an electrocoagulation cell is well documented in the art and is a process of applying a direct or alternating current and voltage to electrodes in contact with an aqueous solution which releases ions into the solution. The released ions cause precipitation of soluble metal and inorganic species and destabilize colloidal suspensions from aqueous solutions. A description of an electrocoagulation cell is provided in International Patent Publication No. WO 01/53568. This also describes use of electrically-connected or unipolar electrodes and bipolar electrodes which are not electrically-connected. The precipitation or suspension (floc) can be removed through separation techniques, such as sedimentation, filtration or electrolytic flotation.

Electrocoagulation separates rather than destroys wastewater contaminants and therefore the nature and disposal of the coagulated contaminant residual is an important consideration. Small volumes of chemically-stable floc are preferable to keep disposal costs at a minimum and prevent recontamination of the environment. Electrocoagulation generates less solid waste (floc) than other technologies, such as chemical precipitation, and does not require addition of chemicals. An electrocoagulated floc tends to contain less bound water, is more shear resistant and is more readily filterable. These factors help keep process costs to a minimum.

Many factors affect electrocoagulation, but the most important factor is the chemistry of the aqueous solution, in particular the conductivity. For example, if the solution is non-conductive electrocoagulation will not occur. Other relevant factors are pH, particle size, chemical constituents and design of the electrocoagulation cell. The prior art teaches that conductivity of the aqueous solution can be increased by the addition of a conductant, such as NaCl, see United States Environmental Protection Agency, September 1993, 540, 504; Environmental Science and Engineering Magazine, www.esemag.com/0103/electro.html. Reference may also be made to Environmental Science and Engineering Magazine, January 2003, www.eeemzg.com. Addition of conductants, in particular NaCl, is generally not a desirable objective especially if the purified water is ultimately destined for human consumption or fresh water waterways. Removal of NaCl from water is very difficult and also very expensive.

The electrocoagulation process generally involves a number of pretreatment and post-treatment steps as shown in U.S. Pat. No. 6,346,197 in the names of Stephenson et al., U.S. Pat. No. 5,531,865 in the name of Cole; and Barkley et al., United States Environmental Protection Agency, September 1993, 540, 504.

Although such electrocoagulation process systems may adequately serve to remove certain contaminants from wastewater, one problem of such systems is that they are overly complicated and not suitable for all types of contaminants. None of the systems can deal with the variability, concentration and number of contaminants found in industrial and human waste. The systems do not demonstrate the flexibility required to efficiently remove contaminants from a wide variety of wastewater. In other words, such systems employ unnecessary components that are only concerned with specific forms of wastewater. For example the electrocoagulation system in U.S. Pat. No. 6,495,048, comprises a flotation tank and vent which is not necessary in most contaminant removal procedures because this process is mainly directed at removal of contaminants from emulsified oily wastewater. In Barkley et al. (supra) the electrocoagulation system comprises a fluidized bed unit that often is not required in wastewater treatment systems. U.S. Pat. No. 5,531,865 describes an electrocoagulation system comprising rotary vacuum filters which is specifically directed for removal of heavy metals from wastewater.

### SUMMARY OF INVENTION

In a first aspect, the invention provides a method of installation of an electrocoagulation system to remove contaminants from wastewater that includes the steps of:
(i) measuring conductivity of the wastewater;
(ii) from the result obtained in step (i) determining the number of electrically-connected electrodes or unipolar electrodes required in the electrocoagulation system for efficient removal of the contaminants; and
(iii) from step (ii) assessing a range of current and/or voltage to be applied to the electrodes of the electrocoagulation cell.

Step (i) can be carried out in any suitable manner, for example, by use of a conductivity probe, as is well known in the art.

In relation to step (ii), it will be appreciated that the conductivity values obtained in step (i) will be dependent on the chemical nature of the wastewater alternatively known as the “sample matrix”. For example, in relation to wastewater that contains non polar contaminants such as oils and greases the conductivity will be less than contaminants that are polar in nature, for example sewage. It will also be appreciated that conductivity of ionic or conductive contaminants such as metals, including heavy metals, and anions such as cyanide and fluoride, will be higher than polar or non polar contaminants.

For example, in relation to the processing of wastewater containing radioactive species, which may contain any elemental oxide, halide or salt which comprises a radioactive isotope or is capable of forming a radioactive isotope, suitable conductivity values may range between 300-2000 μS/cm depending upon the chemical nature of the wastewater. In relation to wastewater containing cyanide, suitable conductivity may range between 33004000 μS/cm.

It will be appreciated that the range of conductivity of various samples of wastewater may vary from relatively low values (200-500 μS/cm) which is applicable to wastewater containing engine oil and wastewater from textile factory waste containing dyes, medium values (500-1000 μS/cm) which is applicable to grey water from showers and wash basins, and high values (>1000 μS/cm) which is applicable to restaurant wastewater, radioactive waste, electroplating effluent, metals tailings ponds and grinding circuit effluent (i.e. having reference to machine shop grinders).

In relation to step (ii) it has been found that a suitable number of unipolar electrodes for high conductivity values, as described above, is 2 out of 8 unipolar electrodes. For medium conductivity values, 2-4 out of 8 unipolar electrodes are suitable. For low conductivity values, 4-8 out of 8 unipolar electrodes are appropriate. This will have specific regard to an 8 electrode system where all electrodes have a fixed spacing between each electrode.

When a greater number of electrodes are employed with the electrocoagulation system such as 15, 18 and 24 electrodes the number of unipolar electrodes will be increased as a general rule but may also stay the same as voltage decreases and current increases. This trend is shown in Example 1 herein. However, the number of unipolar electrodes used may decrease substantially as conductivity and voltage increases and current decreases [Example 1(d)].

Preferably, in the process of the invention an initial sample of a particular wastewater stream is taken at a site at which the electrocoagulation system is to be installed. This sample is then initially checked for conductivity as described above and use may then be made of a bench-type electrocoagulation (EC) system or circuit as hereinafter described.

It will be appreciated that electrocoagulation variables such as the number of electrode connections and voltage and current values of the electrocoagulation cell having regard to a particular sample by use of the bench-type electrocoagulation system can be determined experimentally.

Also, if required, other variables such as the material from which the electrodes are made, pH of the wastewater stream, distance between the electrodes, cell residence time of the wastewater, flow rate and surface area of the electrodes may also be determined, in some cases having regard to the initial conductivity which is determined in step (i) of the method of the invention. Preferably, step (i) is carried out independently of use of the bench-type EC system but in some cases step (i) may be carried out using a conductivity probe or microprocessor which is part of the bench-type EC system.

It will be appreciated that the results obtained from steps (ii) and (iii) can be determined and checked experimentally as described above and provide a highly efficient and cost effective method of installation of an electrocoagulation system to a factory site which processes wastewater that can comprise a number of different types of wastewater streams as described above. If the configuration of the electrocoagulation cell is not set-up correctly taking into account the abovementioned parameters for the specific contaminant composition of the wastewater, efficient removal of the contaminants will not occur.

In relation to steps (ii) and (iii) having regard to the bench-type EC system, it is possible to determine voltage and current in categories of low (L), medium (M) and high (H) values, wherein L, M and H in relation to ranges of voltage and current are given in Example 3.

Thus it is suitable to provide voltage and current in nine separate classifications i.e. L-L, L-M, L-H, M-L, M-M, M-H, H-L, H-M, and H-H. Thus for example, when the conductivity value is low and the voltage-current classification is H-H, then it is usual to have all 8 electrodes of the EC cell electrically connected. When the conductively value is high and the voltage-current classification is L-L then it is usual to have only 2 electrodes of the 8 electrodes electrically connected.

However it must be pointed out that usually if an L-L classification is obtained no reaction may occur in the EC cell and if a H-H classification is obtained this is undesirable because more rapid and unnecessary depletion of the electrodes may occur.

The method of determination of the voltage-current classification may be determined from knowledge of the sample matrix having regard to the criteria given above and use of a variac which is adjustable to increase or decrease voltage and current. The variac may be part of the EC cell in the bench-type EC system as hereinafter described in relation to the preferred embodiment in FIGS. 2-3.

### BRIEF DESCRIPTION OF THE DRAWINGS

Reference may now be made to a preferred embodiment of the invention as shown in the attached drawings wherein:

FIG. 1: View of a batch or bench-type electrocoagulation system used in steps (ii) and (iii) of the method of the invention.

FIG. 2: Front view of an EC cell used in the electrocoagulation system of FIG. 1.

FIG. 3: Side view of the EC cell shown in FIG. 2.

FIG. 4: Partial view of an electrocoagulation system installed by the method of the invention showing preliminary process steps which are applied to a uranium contaminant wastewater stream.

FIG. 5: Partial view of an electrocoagulation system installed by the method of the invention showing preliminary process steps, electrocoagulation treatment and separation and removal of the solids from the wastewater.

FIG. 6: Partial view of an electrocoagulation system showing an alternative method of separation and removal of solids from the wastewater after passage through the electrocoagulation cell.

FIG. 7: Schematic view showing a support assembly for a plurality of bipolar and unipolar electrodes which may be used in the EC cell of FIGS. 5 or 6.

### DETAILED DESCRIPTION OF INVENTION

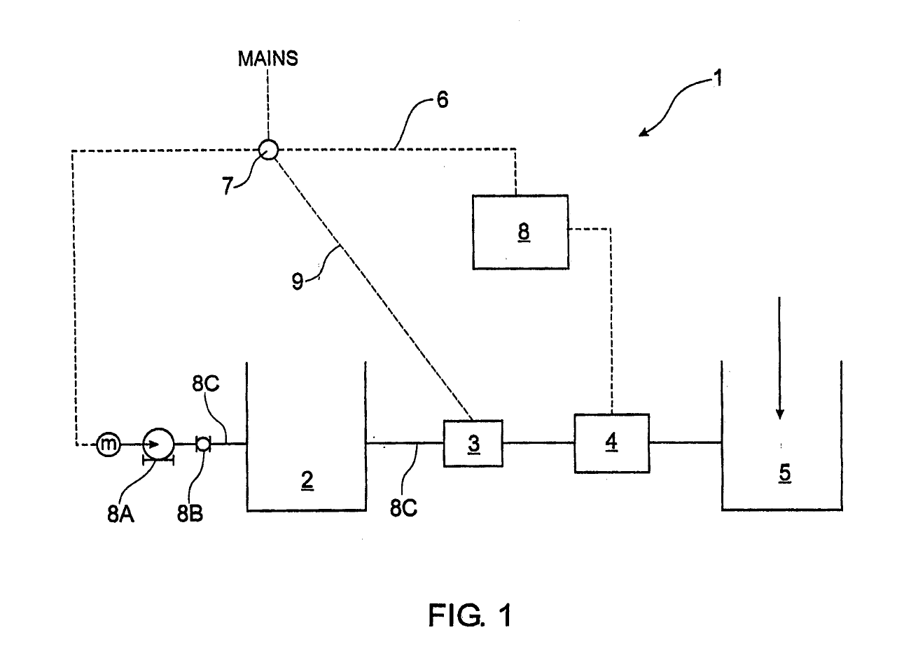

In its simplest form (see FIG. 1) the bench-type EC system 1 will include a feed tank 2, means for creating variable flow rate of water 3 such as a peristaltic pump and an EC cell 4. Preferably, a discharge tank 5 may also be included in flow communication with the EC cell.

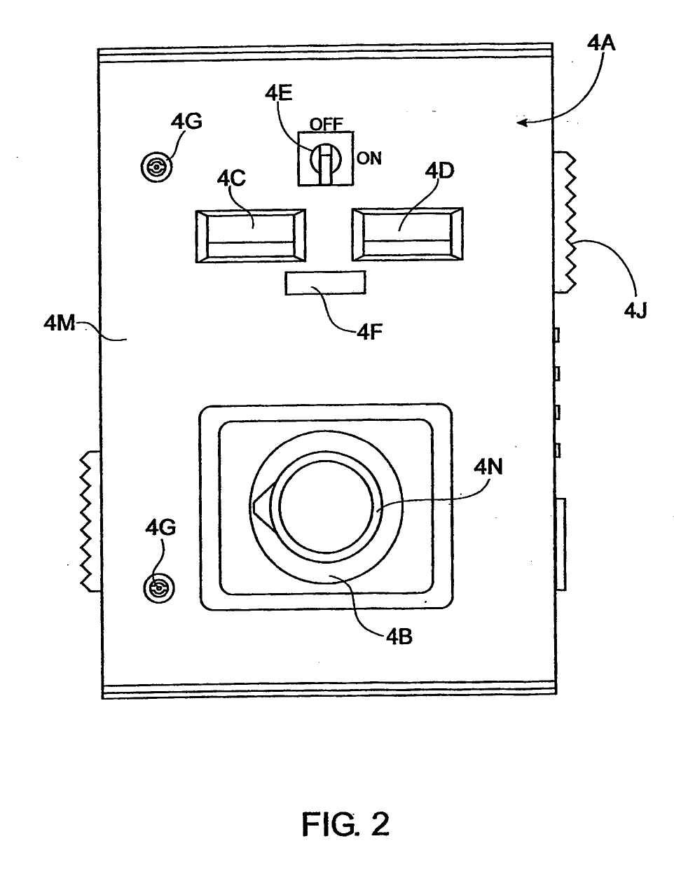

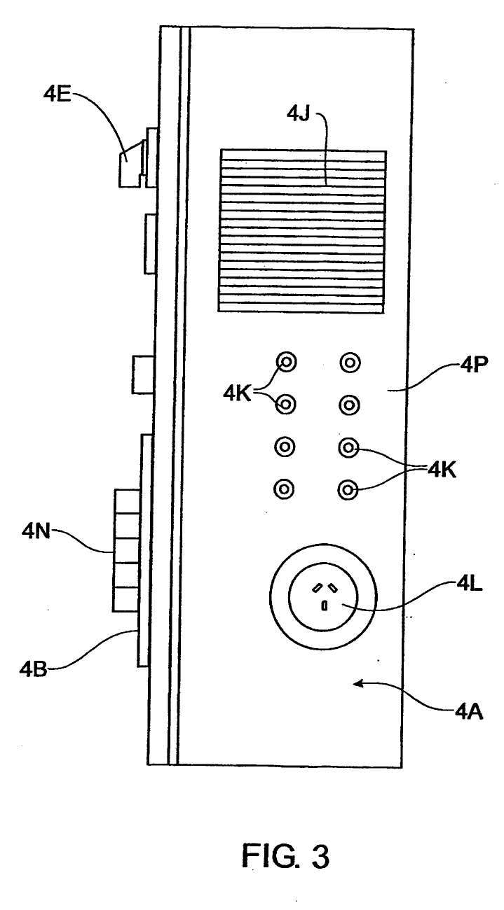

FIGS. 2 and 3 show a front and a side view respectively of EC cell 4 in greater detail having housing 4A, front wall 4M, variac 4B having control knob 4N, voltage display panel 4C, current display panel 4D, on-off switch 4E, on-off light 4F and fasteners 4G connecting wall panel 4H to internal supports (not shown). There is also shown grille 4J in sidewall 4P for an internal cooling fan (not shown), manual connections 4K of a plug-socket type for conductors to electrodes (not shown) and power outlet 4L.

Manual connections 4K may be connected by leads or conductors (not shown), which may be attached to electrodes (not shown) by crocodile type clips. Thus the number of electrically connected electrodes may be varied in an 8 electrode system from 2-8.

From FIGS. 2-3, it will be appreciated that the current may be determined experimentally having regard to a specific voltage value and thus the classifications L-L through to H-H described can be determined empirically. Also the number of unipolar electrodes may be adjusted in regard to step (i) of the method of the invention and the type of sample matrix quickly and efficiently. There is also shown in FIG. 1 delivery pump 8A having motor m and ball valve 8B in the flow conduit 8C. There is also shown control circuit 6 which electrically connects EC cell 4 and power unit 8. Circuit 6 is electrically connected to mains at 7 and pump 3 is also connected to mains by conductor 9.

The flow rate of peristaltic pump 3 may be varied from 0.2-3.0 L/min. Thus a selected flow rate of wastewater may be passed through EC cell 4 before discharge into discharge tank 5 through a pump (not shown) if appropriate.

Voltage and current values which are obtained in bench-type EC system 1 are dependent on the following critical parameters:
(i) number of electrodes electrically-connected to a DC power source;
(ii) total wetted surface area of electrodes in the cell;
(iii) size of the gap between the electrodes;
(iv) conductivity of the wastewater;
(v) flow rate and
(vi) cell residence time of the wastewater through the EC cell.

The optimum parameters can be determined experimentally by a skilled person and parameters (ii), (iii), (v) and (vi) may be kept constant. Once the optimum parameters are obtained from the bench-type EC system shown in FIG. 1 the parameters can be scaled up for use in a full-size system.

It will be appreciated that a smaller cell design with a lower number of electrodes and less total power (voltage and current) is required for bench-type EC systems having low flow rates, i.e. 1 L/min, as described above in comparison to higher flow rates, i.e. between 5-100 L/min which apply to EC systems which are installed by the method of the invention.

Other important factors are the linear velocity of the solution through the cell and the cell residence time. For example, laminar flow is preferred over turbulent flow and thus it is preferred that EC cell 4 has a series of parallel electrodes which does not have serpentine or turbulent flow. If laminar flow is desired for a particular wastewater sample, for example-in this case uranium contaminanated wastewater, the following parameters and electrocoagulation set-up is preferable: (a) cell residence time of 7 seconds; (b) a linear flow velocity through the cell, (c) orientated solution entry at the bottom of the cell, and (d) solution output vertically above the solution entry point and at the top of the cell.

Prior to electrocoagulation treatment by the bench-type model the wastewater sample may also be assessed for percentage of suspended solids, solid particle size and pH. The results of these assessments will demonstrate whether it is advisable to install electrocoagulation pre-treatment steps, such as hydrocyclones or filters to remove suspended solids, and pH monitors to ensure the pH is maintained within a suitable range. The optimum pre-treatment process steps can be chosen for the particular wastewater stream.

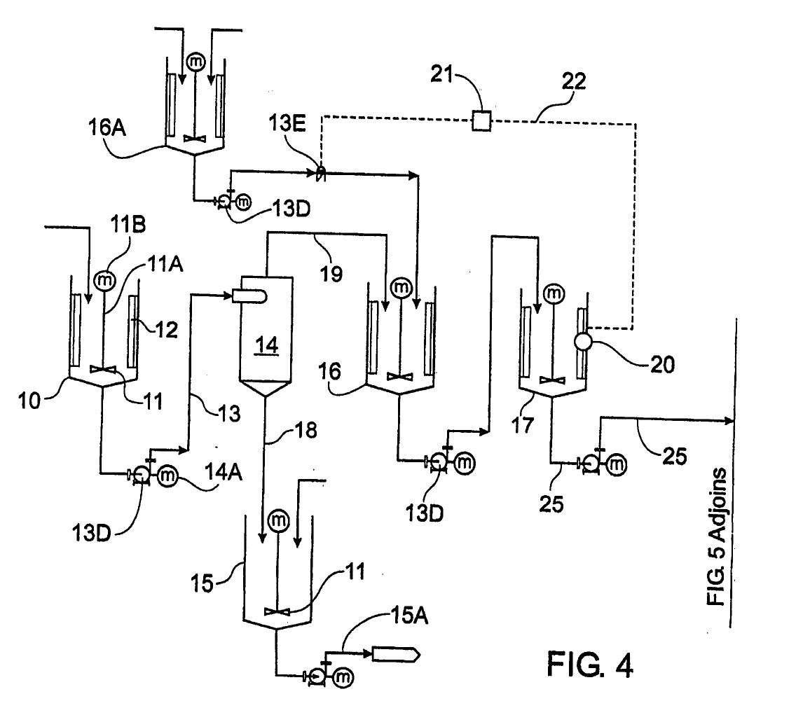

A detailed description of FIGS. 4-7 follows which may be applied to uranium contaminated wastewater. The EC system of FIGS. 4-7 may remove greater than 99.5% of the uranium from the wastewater stream.

Prior to set-up or installation of the EC system of FIGS. 4-7 at the installation plant, a sample of the wastewater for treatment was obtained. The conductivity of the wastewater was measured and found to have various values as described in Example 1. The number of unipolar electrodes having regard to an 8 electrode EC cell were then determined and voltage and current ranges were determined as also described in Example 1.

The abovedescribed method of installation of a contaminant removal process resulted in an electrocoagulation system suitable for processing wastewater contaminated with uranium species as shown in FIGS. 4-7 and is included to illustrate the benefits of the installation method of the invention.

The preferable embodiment for uranium contaminant removal from wastewater is as follows:

It may be necessary to pretreat the wastewater prior to its passing through the electrocoagulation process. Preferably, the pre-treatment process involves removal of excess suspended solids and adjusting the pH of the wastewater.

If the wastewater comprises a high percentage of suspended solids (greater than 200 mg/L) the wastewater enters the pre-treatment process at tank 10 (FIG. 4) where the wastewater is maintained in an agitated condition to maintain the solids in suspension. An agitator, such as an impeller 11 prevents settling of the solids and maintains the solids in suspension. The impeller 11 has a shaft 11A and is driven by motor 11B. Each tank is also provided with one or more baffles 12 to facilitate maintaining the solids in suspension.

The wastewater is transferred from tank 10 into a hydrocyclone 14 through conduit 13 which has a pump 13D which is actuated by a motor 14A. The hydrocyclone 14 uses centrifugal force to separate suspended solids from the liquid stream and thus provide a solids concentration of 200 mg/l or less.

Preferably, the cyclone is a non-mechanical scroll-like cylinder.

Preferably, the diameter of the cyclone is less than 0.5 m.

A plurality of cyclones in parallel may be used to handle large flow streams that would exceed the capacity of a single cyclone.

The underflow or residue from the cyclones is directed to a sludge thickener tank 15. The liquid overflow, which can still comprise suspended solids is directed to tank 16.

The sludge thickener tank 15 uses an agitator and thickening agents to agglomerate the solid particles.

Preferably, the thickening agents or flocculants are long chain hydrocarbons (up to 100 carbon atoms in length).

More preferably, the thickening agents are polyelectrolytes. A preferred polyelectrolyte is an anionic based polyelectrolyte (i.e. two long chain hydrocarbon having anionic end groups), such as AE1125, available from G E Betz (formerly known as Betz Dearborn).

Other flocculants which may be added to the sludge thickener tank 15 to promote particle growth and rapid sedimentation include KlarAid, Novus CB Aqueous Dispersion Polymers and Novus CE Emulsion Polymers. The sludge is disposed though conduit 15A for disposal. The underflow from hydrocyclone 14 is passed into tank 15 through conduit 18.

The liquid overflow in hydrocyclone 14 is transferred to tank 16 through conduit 19. Agitators mix the wastewater in tanks 16 and 17 as shown and a pH sensor 20 is located in tank 17, below the water level, to measure the pH of the wastewater on a continuous basis using an automated controller or microprocessor 21. A signal proportional to the pH of the wastewater is transmitted via a conductor 22 to controller 21 that governs the operation of a control valve 13E that controls the flow of acid or alkali solution from tank 16A to tank 16.

If the pH of the wastewater is greater than 9.5, an acid solution prepared in tank 16A is added to mixing tank 16. Preferably, the acid solution is a mineral acid, such as sulphuric or hydrochloric acid.

If the pH of the wastewater is less than 3.0, alkali solution is added to mixing tank 16. Preferably, the alkali solution is sodium hydroxide or potassium hydroxide or an alkaline earth species such as calcium hydroxide or lime. This system maintains the pH within the desired range for electrocoagulation and the pH can be adjusted to fall within any desired range. For example, maintaining the pH between the limits of 5.5 and 8.5 pH may further enhance the electrocoagulation performance. The variations in pH can be controlled by the automated control system to be within ±0.5 pH units of the desired pH.

If the suspended solid particle size in the wastewater is greater than 100 μm, the wastewater is passed via conduit 25 through a pair of filters 24, which clarifies the wastewater by removing micrometer and submicrometer (0.5-1.5 μm) particles. The filter can be a belt press or plate and frame type filter, and preferably at least two filters are necessary in case maintenance is required on a filter. Reference is also made to flow control valves 26, which control flow of influent into and out of filters 24 through conduits 25, 29 and 30.

The solids from the filter underflow are collected and disposed 33 through conduits 27, 28 and 28A.

The liquid overflow from filters 24 can be transferred to tank 32 through conduit 31. Agitators mix the wastewater in tank 32 and a conductivity detector 34 is located in tank 32, below the water level, to measure the conductivity of the wastewater on a continuous basis.

The outflow from mixing tank 32 then passes into the electrocoagulation treatment zone 39 to undergo electrocoagulation through conduit 40 to feed tank 41. A preferred embodiment of an electrocoagulant cell is described in International Patent No. WO 01/53568.

The electrocoagulant treatment zone 39, which incorporates tank 41, electrocoagulation cell 42, coagulation tank 43 and conduits 44 and 45, treats the wastewater to induce uranium and/or other radioactive species to precipitate, coalesce, coagulate or otherwise separate from the wastewater. An electric current is passed through the wastewater in electrocoagulation cell 42 via a plurality of flat plate metal electrodes to simultaneously release electrode cations and water anions and induce excitation of uranium ions. An electrochemical reaction occurs whereby uranium complexes out of solution and forms a solid coagulant. A flocculant may be added to tank 43 as described above in relation to tank 15.

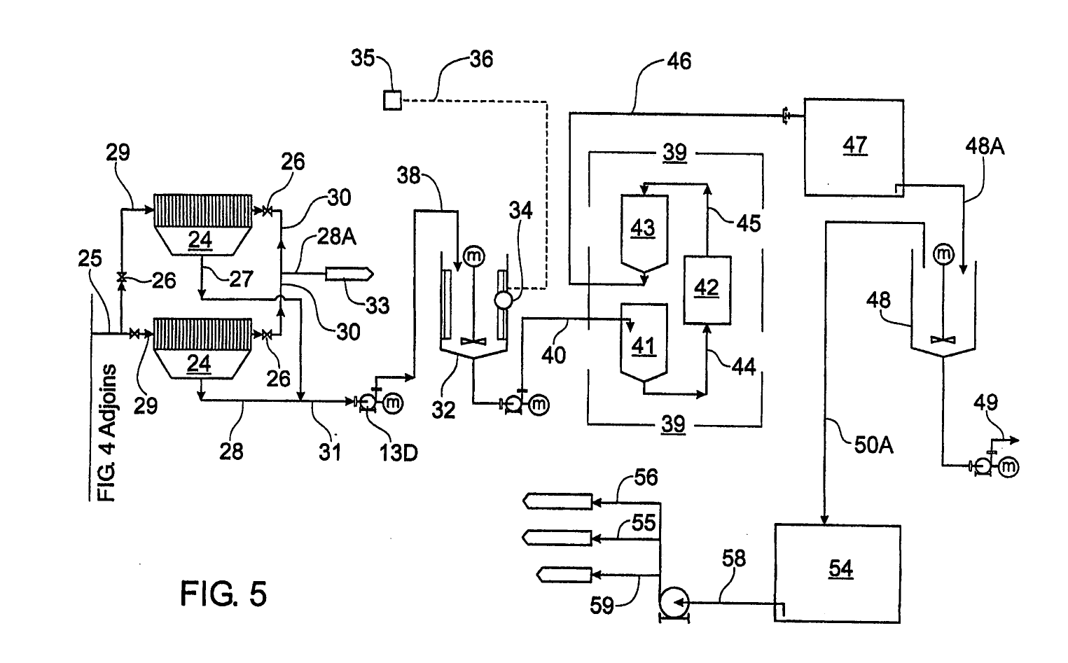

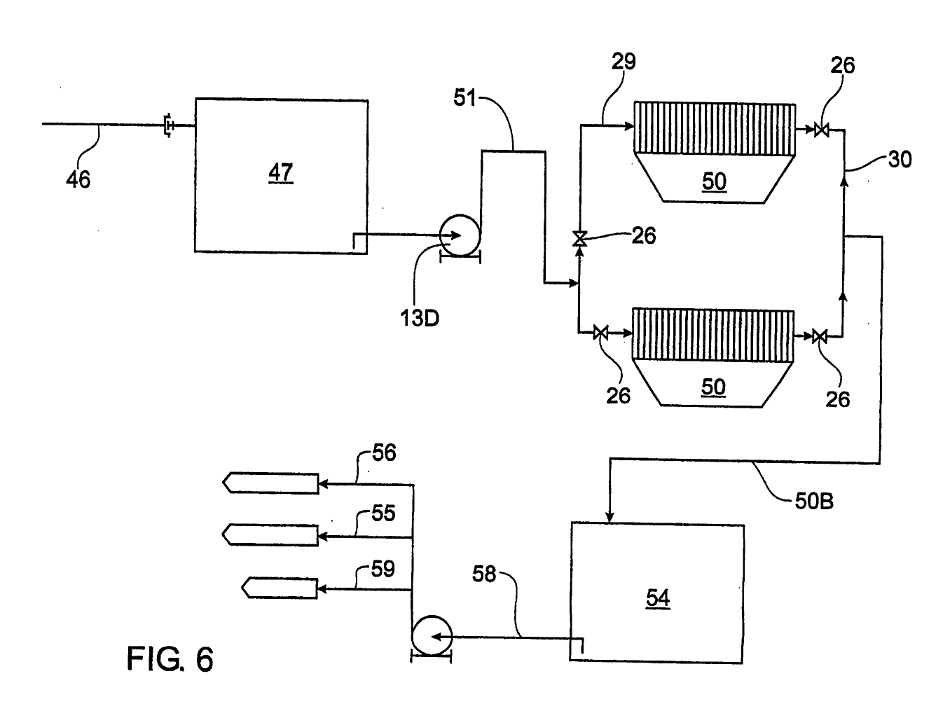

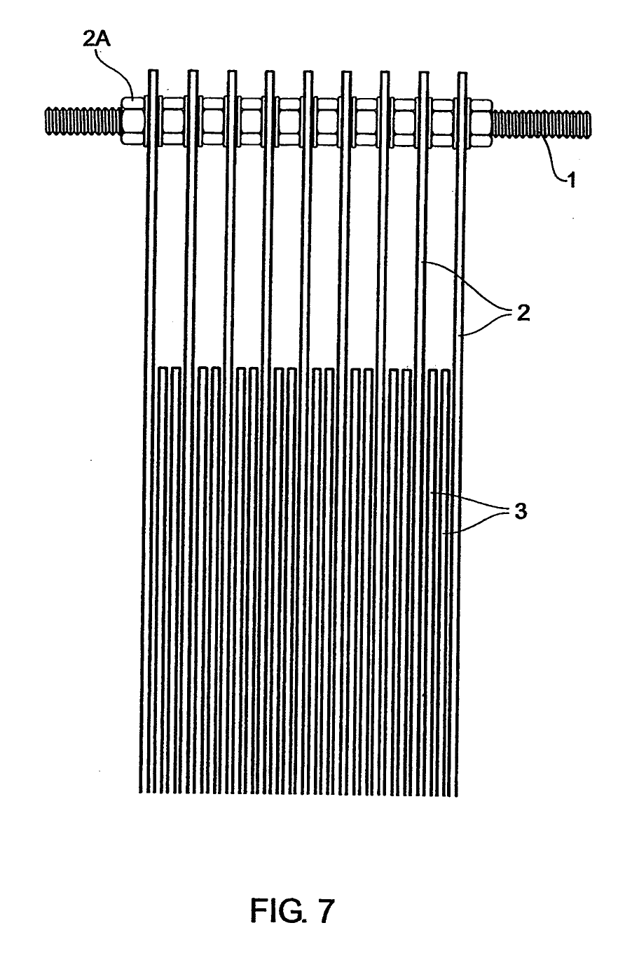

Electrodes are electrically connected to the DC power source via suitably rated cables and a bus bar arrangement (1), which is bolted directly onto each unipolar electrode (2) by bolts (2A) as required (FIG. 7). FIG. 7 also shows an arrangement of unipolar 2 and bipolar 3 electrodes that can be used in the EC cells of FIGS. 5 and 6.

Preferably as determined by EC system 1 shown in FIG. 1, if an electrocoagulation cell comprises 25 electrodes with a gap of 3 mm between each electrode and 9 electrode connections to a DC power source, the voltage applied to the electrocoagulation cell falls within the range 35-110 volts (DC) and the current may fall within the range of 250-490 amps as shown in Example 1. These values will of course be dependent upon the varying characteristics of the sample matrix of uranium-contaminated wastewater.

The power system controlling the electrocoagulation system may be automated to facilitate precise control and to provide flexibility in controlling the electrocoagulation treatment zone 39.

Preferably, the electrocoagulation treatment zone 39 and associated power system is designed to be compact and portable to facilitate transport to and use in industrial plants and mines.

The outflow from the electrocoagulation cell 42 passes to the coagulation tank 43 through an enclosed, sealed plastic conduit 45 that connects the discharge spout of the cell to the coagulation tank or mixing tank 43. The sealed conduit 45 ensures that water vapour or aerosols do not enter the atmosphere and are drawn into mixing tank 43 by a partial vacuum induced by the flowing stream of water within the conduit 45.

Flocculating agents may be added to the mixing tank 43 to accelerate gravity separation of solid particles contained in the discharged wastewater and also to neutralise the anionic or cationic charge of the wastewater. Examples of suitable flocculants can be found in the GE Betz catalogue (www.gebetx.com) and include cationic emulsion polymers and anionic emulsion polymers, such as Novus CE emulsion polymers, polyelectrolytes as described above and AE 1125.

The wastewater may be transferred to a settling tank 47 through conduit 46. The wastewater may remain in a settling tank 47 for one hour. The wastewater may then be passed to a sludge thickener tank 48 through conduit 48A in which particle growth and rapid sedimentation and gravity separation of solid particles occurs. The underflow from the sludge thickener tank 48 may be de-watered or dried prior to disposal by passage through conduit 49 to a suitable disposal location.

As shown in FIG. 6, in an alternative to the embodiment shown in FIG. 5, liquid from the settling tank 47 may also be transferred through conduit 51 to a sand filter or other mechanical filtration system 50, for example, a plate and frame type filter press or belt filter that is used to clarify the liquid stream from the settling tank 47. This may be accomplished by pump 13D drawing the liquid through conduit 51.

The outflow from the sludge thickener tank 48 or filtration system 50 may be transferred through conduits 50A or 50B respectively to a holding tank 54 from which the wastewater may again be treated by passage to the electrocoagulation treatment zone 39 by passage through conduit 55 after passage through conduit 68. Any discharge may be passed through conduit 56. It will be appreciated that any second pass of the wastewater through the electrocoagulant treatment zone 39 may not be required, subject to the efficiency of uranium removal through the first pass treatment cycle. An alternative to discharging the treated wastewater would be to reuse, or recycle the treated water. This is particularly advantageous for industrial applications where water usage is high. Any recycled water may be passed through conduit 59.

Modifications may be made to the uranium removal process. Any of the pretreatment or post-treatment steps may be omitted subject to the nature or composition of the wastewater.

While the invention has been described with the particular reference to a method of installation of an electrocoagulation system for uranium species removal it will be understood that, in a modified form, the invention may also be used for the installation of an electrocoagulation for the removal of other radioactive species from wastewater. Additional or modified pre-treatment and post-treatment process steps may be required when treating wastewater comprising other radioactive species, to contend with differing chemical properties of the radioactive species. Different voltage and current values, different flow rate and cell residence time, different electrocoagulation cell design, different wastewater pH and conductivity, and different electrodes may be required for effective electrocoagulation.

So that the invention may be more readily understood and put into practical effect, the skilled person is referred to the following non-limiting examples.

### EXAMPLES

### Example 1

The following examples apply to all radioactive species including uranyl oxide such as U₃O₈.

(a) Electrocoagulation Parameters for a Fixed Flow Rate of 100 litres/minute and Cell Residence Time of 6.99 seconds

The electrocoagulation cell comprises 25 electrodes with a gap of 3 mm between each electrode. The total wetted electrode surface area is 8.16 m². Electrical connections to a DC power supply are made to 9 electrodes. If the solution conductivity is 330±15% μS/cm, the cell requires 75±15 volts and 314±15% amps.

(b) Electrocoagulation Parameters for a Fixed Flow Rate of 100 litres/minute and Cell Residence Time of 6.99 seconds

The electrocoagulation cell comprises 25 electrodes with a gap of 3 mm between each electrode. The total wetted electrode surface area is 8.16 m². Electrical connections to a DC power supply are made to 9 electrodes. If the conductivity is 630 μS/cm, the cell requires 55±15% volts and 404±15% amps.

(c) Electrocoagulation Parameters for a Fixed Flow Rate of 100 litres/minute and Cell Residence Time of 6.99 seconds

The electrocoagulation cell comprises 25 electrodes with a gap of 3 mm between each electrode. The total wetted electrode surface area is 8.16 m². Electrical connections to a DC power supply are made to 9 electrodes. If the conductivity is 1,230 μS/cm, the cell requires 39±15% volts and 490±15% amps.

(d) Electrocoagulation Parameters for a Fixed Flow Rate of 100 litres/minute

The electrocoagulation cell comprises 24 electrodes with a gap of 3 mm between each electrode. The total wetted electrode surface area is 7.82 m². Electrical connections to a DC power supply are made to 2 electrodes. If the conductivity is 20,000 μS/cm, the cell requires 102±15% volts and 306±15% amps.

### Example 2

The following example applies to installation of an electrocoagulation system for the removal of free and complex cyanide species from wastewater from an industrial process such as aluminium smelters. The wastewater can contain free cyanide ions, such as sodium cyanide, and complexed cyanides such as sodium ferdcyanide and ferrocyanide. Water purity regulations, which specify acceptable levels for a wide range of contaminants in water discharged into waterways, sewer systems or discharged in other manners, dictate that the total cyanide content of discharged water is less than 0.1 mg/L. The EC system used in this example is similar to that shown in FIGS. 4-7.

If the pH of the wastewater is greater than 8.2, an acid solution such as that described above in relation to the FIGS. 4-7 embodiment is added to the wastewater.

If the pH of the wastewater is less than 7.0, an alkali solution such as that described above in relation to the FIG. 5 embodiment is added to the wastewater. This system maintains the pH within the desired range for electrocoagulation and the pH can be adjusted to fall within any desired range. For example, maintaining the pH between the limits of 7.2 and 8.0 may further enhance the electrocoagulation performance. The variations in pH can be controlled by the automated control system to be within ±0.5 pH units of the desired pH.

Conductivity of the cyanide contaminant wastewater which is found to be between 3300-4000 μS/cm and is considered highly conductive.

Preferably, the EC cell electrodes are made of stainless steel, such as alloy grades selected from the austentic group.

More preferably, the electrodes are made from alloy grades 304 and 316 due to the low cost of manufacture and desirable properties, such as corrosion and high temperature resistance and low magnetic response.

The optimum EC cell parameters were calculated using the bench type EC system of FIG. 1.

3 unipolar and 15 bipolar electrodes were used with a gap of 3 mm between each electrode. The voltage applied to the electrocoagulation cell fell within the range 85-100 volts (DC) and the current 285±15% Amps.

Preferably, conduits 44 and 45 of FIG. 5 are made of nonconductive plastics.

Preferably, the plastic is selected from PVC-U (unplasticied polyvinyl chloride), PVC-C (post0chlorinated PVC-U) and ABS (acrylonitrile butadiene styrene).

Most preferably, PVC-C is used due to its resistance to acids and alkalis at high concentrations and high temperatures (up to 90 degrees Celcius). PVC-U and ABS are preferred in applications where temperatures do not exceed 60 degrees Celcius.

The EC-treated wastewater may again be treated by electrocoagulation treatment zone 39 by passage through conduit 55 after passage through conduit 58 as shown in FIGS. 5 and 6. A second pass of the wastewater through the electrocoagulant treatment zone 39 may not be required, subject to the efficiency of cyanide removal through the first pass treatment cycle. An alternative to discharging the treated wastewater would be to reuse, or recycle the treated water. This is particularly advantageous for industrial applications where water usage is high (for example in aluminium smelters). Any recycled water may be passed through conduit 59.

Modifications may be made to the cyanide removal process. Any of the pre-treatment or post-treatment steps may be omitted subject to the nature or composition of the wastewater.

### Example 3

Table 1 shows the desired range of voltage and current to be applied to an EC cell and the optimum electrode type for effective removal of a list of contaminants.

Table 1 also shows that the installation method of the invention may also be used in relation to treatment of wastewater containing high BOD (Biological Oxygen Demand) and high COD (Chemical Oxygen Demand) to reduce values to those suitable for discharge.

All experimental data was carried out using the bench-type EC system of FIG. 1 and steps (i) to (iii) of the installation method. Experimentation was required to achieve the optimum experimental parameters.

An 8 electrode system was used and the number of electrodes connected to the power supply (i.e. unipolar electrodes) depended on the conductivity of the wastewater sample. The number of unipolar connections was calculated as a function of varying wastewater conductivities. 2 unipolar electrodes were used for wastewater with high conductivity as referred to above. 4-8 unipolar electrodes were used for wastewater with low to medium conductivity. There was a fixed and regular spacing between each electrode.

Flow rate of wastewater through the EC cell was 1 L/min.

The following values denote low, medium and high voltage and current:

| | | |
|---|---|---|
| Volts | | |
| 5-20 V - low | 20-60 V - medium | 60-90 V - high |
| Amps | | |
| 2-5 A - low | 5-7.5 A - medium | 7.5-11 A - high |

### Example 4

The following example applies to an EC system for the removal of dye and textile contaminants from a wastewater sample.

Contaminants present in sample—colour, suspended solids, oil and grease

The sample was yellow coloured from a textile wash circuit.

The raw sample had a pH of 7.9 and conductivity 460 μS/cm.

Experimentation commenced using medium to high voltage and medium to high current.

Experimental Results

The most successful treatment was achieved using the following parameters:
Electrode type: Aluminium
Number of electrodes=8
Number of connections=4 (1, 3, 6, 8)
Volts=80
Amps =5.6

Coagulant produced—light density foam with slow settling, evidence of detergents and dyes.

Residual water had a slight yellow colour.

The sample was treated without any adjustment of pH or conductivity.

### Example 5

The following example applies to an EC system for the removal of shower and wash basin contaminants from a wastewater sample.

Contaminants present in sample—suspended solids (dirt), TP (total phosphorous—detergents)

The sample was grey-coloured water with soap suds and dirt in solution.

There were some suspended particles and the sample was stirred sample stirred while treated.

The raw sample had a pH of 5.4 and conductivity 780 μS/cm.

Experimentation commenced using low to medium current and medium voltage.

Experimental Results

The most successful treatment was achieved using the following parameters:
Electrode type: Aluminium
Number of electrodes=8
Number of connections=4 (1, 3, 6, 8)
Volts=35
Amps=4.8

We note that this wastewater sample had a higher conductivity than the sample in Example 4. Therefore fewer volts were required and similar amps were used to achieve electrocoagulation with the same cell configuration.

Coagulant produced—light density foam coagulant and a very clear aqueous layer. Very effective removal of dirt and detergents was observed.

Water re-cycling is an option for the treatment process.

The sample was treated without any adjustment of pH or conductivity.

### Example 6

The following example applies to an EC system for the removal of restaurant discharge contaminants (food and fats) from a wastewater sample.

Contaminants present in sample—suspended solids, total phosphorous (TP—detergents), food, oil and grease (cooking oils), BOD (biological oxygen demand—food proteins), total Kjeldahl Nitrogen (TKN—nutrients).

The sample was grey/brown-coloured water with food particles in solution.

Preferably, the sample is pre-filtered prior to treatment.

The raw sample had a pH of 5.5 and conductivity 1,150 μS/cm.

Experimentation commenced using medium to high voltage and high current.

Experimental Results

The most successful treatment was achieved using the following parameters:
Electrode type: Aluminium
Number of electrodes=8
Number of connections=4 (1, 3, 6, 8)
Volts=50
Amps=9.5

Coagulant produced—high density/large volume foam coagulant due to the high BOD content. Fats and greases were also removed. There was a very clear aqueous layer. Method was highly successful.

Water re-cycling is an option for the treatment process.

The sample was treated with an adjustment to pH. The conductivity was high due to food salts in the sample.

### Example 7

The following example applies to an EC system for the removal of engine oil contaminants from a wastewater sample from a car service facility.

Contaminants present in sample—suspended solids, TP (detergents), car oil and grease (engine oils), petrochemicals and dissolved metals.

The sample was a brown/black emulsion, oil/grease emulsion with dirt and detergents in solution.

The raw sample had a pH of 6.8 and conductivity 490 μS/cm.

Experimentation commenced using medium voltage and low to medium current.

Experimental Results

The most successful treatment was achieved using the following parameters:
Electrode type: Aluminium
Number of electrodes=8
Number of connections=4 (1, 3, 6, 8)
Volts=51
Amps=3.0

Coagulant produced—high density/low volume coagulant

Oils and greases, dirt and other components were removed.

There was a very clear aqueous layer. Therefore the method was successful

Water re-cycling is an option for the treatment process.

The treatment method works across a broad range of pH and conductivity.

### Example 8

The following example applies to an EC system for the removal of electroplating contaminants from a wastewater sample.

Contaminants present in sample—suspended solids, TP (detergents), car oil and grease (engine oils), petrochemicals, dissolved metals.

The sample was milky coloured with slight cyanic odour.

The raw sample had a pH of 6.0 and conductivity 850 μS/cm

Experimentation commenced using high voltage and high current.

Experimental Results

The most successful treatment was achieved using the following parameters:
Electrode type: Iron
Number of electrodes=8
Number of connections=4 (1, 3, 6, 8)
Volts=70
Amps=9.6

Coagulant produced—low density green metals coagulant

Very clear aqueous layer. Therefore method was successful.

Water re-cycling is an option for the treatment process.

A slight odour was detected therefore the effluent should be checked for cyanide. Additional cyanide removal treatment is likely to be required.

The treatment method works across a broad range of pH and conductivity.

### Example 9

The following example applies to an EC system for the removal of grinding circuit contaminants from a wastewater sample.

Contaminants present in sample—suspended solids, TP (detergents), oil and grease, dissolved metals.

The sample was a white coloured water from a grinding circuit.

The raw sample had a pH of 10.02 and conductivity 1,320 μS/cm.

Experimentation commenced using medium voltage and high current.

Experimental Results

The most successful treatment was achieved using the following parameters:
Electrode type: Iron
Number of electrodes=8
Number of connections=2 (1, 8)
Volts=40.0
Amps=9.9

Coagulant produced—green metals/grinding oils based coagulant, dense foam, rapid settling, large volume initially which settles to low volume.

Clear solution obtained upon settling

The sample was treated with a pH adjustment to 6.2 (range 6-6.5 preferred).

A high conductivity sample requires only two electrode connections.

### Example 10

The following example applies to an EC system for the removal of electroplating contaminants from a wastewater sample.

Contaminants present in sample—dissolved metals, CN (cyanide) in clear water from an electroplating process.

The raw sample had a pH of 7.2 and conductivity 2,230 μS/cm.

Experimentation commenced for metals removal with low to medium voltage and high current.

Experimentation commenced for cyanide removal with high voltage and low to medium current.

Experimental Results

Treatment 1—Removal of Metals
Electrode type: Iron
Number of electrodes=8
Number of connections=4 (1, 3, 6, 8)
Volts=20.0
Amps=7.6

Coagulant produced—brown/green metals based coagulant, dense foam, rapid settling, large volume initially which settles to low volume.

Clear solution was obtained upon settling.

The cyanide smell remained.

Treatment 2—removal of cyanide

The sample was adjusted to a pH OF 6.2 (range 6-6.5 is required).
Electrode type: Stainless Steel
Number of electrodes=8
Number of connections=2 (1, 8)
Volts=85.0
Amps=3.0

Coagulant produced—yellow/orange cyanide based coagulant, no foam, slow settling, small volume.

Clear solution was obtained upon settling

Cyanide type smell not evident.

### Example 11

The following example applies to an EC system for the removal of petrochemical contaminants from a wastewater sample.

Contaminants present in sample—hydrocarbons and COD (chemical oxygen demand)

The sample was a white/grey coloured water with evidence of hydrocarbons and COD.

The raw sample had a pH of 7.00 and conductivity 2,580 μS/cm.

Experimentation commenced using medium voltage and high current.

Experimental Results

The most successful treatment was achieved using the following parameters:
Electrode type: Aluminium
Number of electrodes=8
Number of connections=4 (1, 3, 6, 8)
Volts=45.0
Amps=9.9

Coagulant produced—dense foam, large volume which settles rapidly to low volume.

A clear solution was obtained upon settling.

The sample was treated without a pH adjustment.

The advantages of the installation method of this invention are as follows:
(i) the method results in a custom-made electrocoagulation system that produces the maximum contaminant removal for a specific wastewater sample;
(ii) addition of NaCl or other conductants to the wastewater stream is not necessary and in some cases may be undesirable;
(iii) a minimum amount of chemicals are used in the process;
(iv) having assessed the wastewater sample matrix any required pretreatment and post-treatment process steps can be determined prior to installation of the electrocoagulation system at the installation site. This results in a simplified and compact system that is custom-made for the specific contaminants present in the wastewater;
(v) the EC system when installed by the method of the invention results in an efficient electrocoagulation system that prevents unnecessary downtime for replacement of sacrificial anodes or cathodes and provides a system that can be easily maintained;
(vi) the EC system when installed by the method of the invention enables wastewater to be treated on a continuous flow treatment basis, enabling the rapid treatment of large volumes of water;
(vii) the EC system when installed by the method of the invention results in a low volume, aqueous stable sludge that is readily separated from a liquid stream for subsequent disposal. Typically the EC system when installed generates a much lower amount of sludge compared to conventional methods;
(viii) the process can perform effectively the simultaneous treatment of multiple contaminants; and

(ix) the EC system when installed by the method of the invention is automated, compact and portable.

TABLE 1

| | Electrode | | |
|---|---|---|---|
| Contaminant | material | Volts | Amps |
| BOD | Aluminium | Low | High |
| COD | Aluminium | Medium | High |
| TKN | Aluminium | Medium | Medium |
| TP | Aluminium | Medium | Low |
| Suspended Solids | Aluminium | Low | Low |
| Faecal Coliform & | Aluminium | Medium | High |
| Algaes | | | |
| Oil & Grease | Aluminium | Medium | High |
| Total HC's. | Aluminium | Medium | High |
| Benzene | Aluminium | High | High |
| Sulphate | Aluminium | High | High |
| Colour | Aluminium | Medium | Medium |
| Aluminium | Iron | Medium | Medium |
| Arsenic | Aluminium | Low | High |
| Antimony | Iron | High | High |
| Calcium | Iron | Medium | Medium |
| Cadmium | Iron | High | High |
| Cobalt | Iron | High | High |
| Chromium | Iron | Medium | High |
| Copper | Iron | Medium | Medium |
| Iron | Iron | Medium | Medium |
| Lead | Iron | Medium | High |
| Magnesium | Iron | Medium | Medium |
| Manganese | Iron | Medium | Medium |
| Mercury | Iron | High | Medium |
| Molybdenum | Iron | High | High |
| Nickel | Iron | High | Medium |
| Silicate | Iron | High | Medium |
| Tin | Iron | Medium | Medium |
| Vanadium | Iron | High | High |
| Zinc | Iron | Medium | Medium |
| Cyanide | Stainless | High | High |
| | Steel | | |

1. A method of installation of an electrocoagulation (EC) system to remove contaminants from wastewater which includes the steps of:
(i) measuring conductivity of the wastewater;
(ii) from the result obtained in step (i) determining the number of electrically connected electrodes or unipolar electrodes required in the EC system for efficient removal of the contaminants, and
(iii) from step (ii) assessing a range of current and/or voltage to be applied to an EC cell included in the EC system.

2. A method as claimed in claim 1 wherein (ii) may be obtained from the chemical nature of the wastewater as well as the result of step (i) thereby is leading to a range of conductivities selected from the group consisting of (a) low conductivity being 200-500 μS/cm leading to 4-8 unipolar electrodes in a total electrode system of 8 electrodes, (b) medium conductivity being 500-1000 μS/cm leading to 2-4 unipolar electrodes out of a total electrode system of 8 electrodes and (c) high conductivity being greater than 1000 μS/cm leading to 2 unipolar electrodes out of a total electrode system of 8 electrodes.

3. A method as claimed in claim 1 wherein as the total number of electrodes in the EC system exceed 8 the number of unipolar electrodes will stay the same as voltage decreases and current increases.

4. A method as claimed in any preceding claim wherein step (i) is carried out using a conductivity probe of a wastewater sample.

5. A method as claimed in claim 4 wherein step (ii) is carried out using a bench type EC system having a feed tank, means for providing liquid flow at variable flow rates, and an EC cell.

6. A method as claimed in claim 5 wherein the bench type EC system also includes a discharge tank in flow communication with the EC cell and located downstream thereof.

7. A method as claimed in any preceding claim wherein there is provided a plurality of unipolar electrodes which are releasably mounted in the EC cell.

8. A method as claimed in any preceding claim wherein step (iii) is carried out using a classification of voltage and current ranges selected from the group consisting of the following:
(a) Low voltage—low current
(b) Low voltage—medium current
(c) Low voltage—high current
(d) Medium voltage—low current
(e) Medium voltage—medium current
(f) Medium voltage—high current
(g) High voltage—low current
(h) High voltage—medium current
(i) High voltage—high current
wherein low voltage is 5-20 volts, medium voltage is 20-60 volts and high voltage is 60-90 volts and low current is 2-5 amps, medium current is 5-7.5 amps and high current is 7.5-11 amps whereby one or more of classifications (a) to (i) is attempted to determine optimum voltage and current for a particular wastewater sample.

9. A method as claimed in claim 8 wherein in relation to a sample of low conductivity of 460 μS/cm step (iii) is carried out using classification (e) following by classification (i).

10. A method as claimed in claim 8 wherein in relation to a sample of medium conductivity of 780 μS/cm step (iii) is carried out using classification (d) followed by classification (e).

11. A method as claimed in claim 8 wherein in relation to a sample of high conductivity of 1150 μS/cm step (iii) is carried out using classification (f) followed by classification (i).

12. A method as claimed in claim 8 wherein in relation to a sample of low conductivity of 490 μS/cm step (iii) was carried out using classification (d) followed by classification (e).

13. A method as claimed in claim 8 wherein in relation to a sample of medium conductivity of 850 μS/cm step (iii) was carried out using classification (i).

14. A method as claimed in claim 8 wherein a sample of high conductivity of 1320 μS/cm step (iii) was carried out using classification (f).

15. A method as claimed in claim 8 wherein in relation to a sample of high conductivity of 2230 μS/cm step (iii) was carried out using classification (c) followed by classification (f to remove metals.

16. A method as claimed in claim 15 wherein in relation to the sample of 2230 μS/cm step (iii) was subsequently carried out using classification (g) followed by classification (h) to remove cyanide.

17. A method as claimed in claim 8 wherein in relation to a sample of high conductivity of 2580 μS/cm step (iii) was carried out using classification (f).

18. A bench type electrocoagulation (EC) system which may be used in the method of claim 1 comprising:
(1) a feed tank;
(2) means for creating variable flow rates of liquid in flow communication with the feed tank; and
(3) an EC cell having a variable voltage control in flow communication with the means for creating variable flow rates.

19. A bench type EC system as claimed in claim 18 wherein the means for creating flow rates is a peristaltic pump.
